(19) United States
(12) Patent Application Publication
(10) Pub. No.: US 2008/0255747 A1
(43) Pub. Date: Oct. 16, 2008

(54) Device for Controlling an Internal Combustion

(76) Inventors: Bernhard Valouch, Eppingen (DE); Harald Schueler, Backnang (DE)

Correspondence Address: KENYON & KENYON LLP, ONE BROADWAY, NEW YORK, NY, 10004, US

(21) Appl. No.: 11/793,664

(22) PCT Filed: Dec. 12, 2005
(86) PCT No.: PCT/EP2005/056666

§ 371 Date: Jan. 11, 2008

(30) Foreign Application Priority Data
Jan. 12, 2005 (DE) 10 2005 001 425.9

(51) Int. Cl. F02D 45/00

(52) U.S. Cl. 701/102

(57) ABSTRACT

A device for controlling an internal combustion engine includes a control unit that reads out data from a data medium and/or writes data into this data medium and uses it for control, the data medium being assigned to at least one actuator, and this actuator containing characterizing data. The data is read out from the data medium and/or the data is written into the data medium by an oscillating circuit, whose components are situated in the control unit and/or in a circuit assigned to the actuator.

### BACKGROUND OF THE INVENTION

1. Field of the Invention

The present invention relates to a device for controlling an internal combustion engine, which device includes an oscillating circuit for reading and writing of data.

2. Description of Related Art

Methods and devices for controlling an internal combustion engine, in which a control unit reads out data from a data medium and uses it for control, are known from practice. The data medium is assigned to at least one actuator and contains data which characterizes this actuator. Thus, for example, injectors which meter fuel of an internal combustion engine as a function of an activation signal have a data medium which contains correction values, using which deviations within a tolerance band of the individual injectors may be compensated for. This correction data is ascertained at the end of the manufacturing process of the injector and input into the data medium. The data medium may be implemented in greatly varying ways, for example, as a barcode or as a read-only memory element.

A system for ascertaining information, in which a unit for storing information about the components is a data transponder situated on the component, is described in published German patent document DE 102 13 349. Situating the data transponder directly on the component has the advantage that it may be read out in a way that is particularly reliable for the process. In particular, it is not subjected to external influences, such as oil/dirt and the like. Contact problems at a component/read device interface, which may result in incorrect programming, are thus also precluded.

The information stored on the data medium or the unit for information storage is input during the first initialization of the control unit and used in later operation for controlling the internal combustion engine. The control units contain different functions which also ascertain correction values which are assigned to an injector. Such a function, for example, is the zero quantity calibration. For this purpose, the data is typically merely stored in the control unit and used to control the internal combustion engine.

In addition, the individual injected fuel quantity of an injector is detected at multiple checkpoints. The deviation of the particular injected fuel quantity from the setpoint value is ascertained. This data is placed during manufacturing of the injector in suitable form on the injector or, for example, stored in the above-mentioned transponder. During the engine assembly and/or during the vehicle assembly, the data is transmitted via suitable systems, for example, via a camera system or using a diagnostic interface or using suitable readout systems for reading out transponders.

If the control unit is replaced, the data placed or stored on the injector must be input again via the diagnostic interface or the camera system or another read system. The other correction values already ascertained by the control unit must be read out from the old control unit in this case and transferred into the new control unit. For this purpose, specific functions of the diagnostic interface and/or the control unit and/or a service tester are again necessary. In order to minimize the resulting effort for this purpose, published German patent document DE 102 44 091 suggests that the data medium be implemented on the injector in such a way that the control unit writes data into the data medium. Simpler exchange of the control unit in the event of a defect is thus possible. It is especially advantageous that replaceability of parts without problems, in particular the control unit, is provided without the use of specific, manufacturer-dependent tools or testers.

In this system, the transponder is situated externally on the component to allow the best possible data transmission. Because of this exposed position, however, the danger now exists of damage to the transponder, in particular if the component is an injector for injecting fuel, which is subjected to rough usage conditions.

Furthermore, such a system requires an antenna, using which the data is read out of the transponder. An additional component and supply lines to this component are thus necessary, which cause additional assembly effort and additional costs. Finally, the antenna itself may also be subjected to interference which impairs the readout of the data.

Furthermore, integrating electronic components in a plug connector of the injector is also known. The values of these components are used in this case for classifying the injector. The electrical values are read out by circuits in the control unit or in a programming unit. It is disadvantageous in this approach that at least one additional plug terminal pin is required so that the actual function of the injector is not disadvantageously impaired.

An object of the present invention is further simplifying a device for controlling an internal combustion engine in such a way that with the least possible assembly effort, fail-safe bidirectional data transmission is made possible between the control unit and the actuator, such as an injector for injecting fuel into the combustion chamber of an internal combustion engine.

### SUMMARY OF THE INVENTION

The present invention provides performing bidirectional data transmission between a control unit and an actuator, such as an injector for fuel injection, through an electrical oscillating circuit, the components of the oscillating circuit, inductors, capacitors, and the like, being situated in the control unit and/or in the actuator, i.e., for example, situated only in the control unit or only in the actuator or also distributed to the control unit and the actuator. In particular, in this way transmission of the data about properties of the injector or other data which is stored in data memory elements of the injector to the control unit and, vice versa, transmission of data from the control unit to the data memory elements of the injector, may be implemented optimally.

It is particularly advantageous that the oscillating circuit produces a modulated AC voltage signal, which is transmitted via supply lines of the actuator. In this way, no additional data lines, plug pins, or the like are necessary. Rather, the data transmission is performed very advantageously via the supply lines of the injector for fuel injection, for example.

The data is transmitted using modulation of an AC voltage signal. The AC voltage signal may be modulated in greatly varying ways, for example, through amplitude modulation, frequency modulation, or also through phase modulation.

If multiple actuators, i.e., for example, multiple injectors, are connected to the control unit using a shared signal path, the AC voltage signal may additionally have selection elements, through which selector circuits in the injectors are addressed. Likewise, identifiers such as serial numbers or the like may be contained in the data transmission signals output by the injectors.

If the actuators, such as injectors, are electrically connected at one of their poles and the particular other pole is connected to switching elements inside or outside the control unit—for example, in external output stages—the actuator with which data communication is to occur may be selected by these switching elements or other switching elements situated parallel thereto.

In addition, circuit systems are provided which avoid rectifying effects as much as possible. In many cases, the control units have output stage topologies which have one or more freewheeling diodes for implementing slower and/or faster freewheeling of the energy of the magnetic field of the actuator(s) for the purpose of current regulation or energy reclamation. Parasitic anti-parallel diodes in some transistor types, such as MOSFETs, or additionally provided discrete anti-parallel diodes in circuits having IGBTs (insulated gate bipolar transistors) for the sinusoidal AC voltage signals used, which are usually in the high-frequency range, also act as rectifiers and unfavorably deform the curve of the signals. This may result in malfunctions and emission of undesired high-frequency interference because of the harmonics contained in nonsinusoidal signals. The circuits for avoiding these rectifier effects may be implemented, for example, by operating the above-mentioned diode sections in a targeted way using a bias voltage in the reverse direction which is sufficient for the signal. This bias voltage may be produced ratiometrically to the overall supply voltage, so that the signal amplitude for improving the data transmission security and for ensuring the energy transmission to the power supply preparation for the circuit system in the actuator, described in greater detail below, may reach a sufficiently large value.

The data transmission may occur in times during which, for example, no injection operations occur in an injector. However, it is also possible to perform the data transmission when the essentially constant activation signals exist for a sufficiently long time. In this way, the function of the actuator, such as the injector, is not impaired during the data transmission. There is also no electromagnetic interference, which may exceed legal limiting values. Unintentionally turning on the actuator acting as the consumer is also very advantageously precluded in this way.

The components of the oscillating circuit may be situated in the control unit and/or in the circuit assigned to the actuator as a function of the actuator used. The subcircuits of the oscillating circuit may be coupled capacitively and/or via electronic or electromechanical switches to existing output stage circuits of the control unit. The mode of operation of the output stage and the actuator, such as the injector for fuel injection, is thus not impaired.

It is also possible to use two discrete sine frequencies or on/off keying of the oscillator for the data transmission in the simplest case. Data transmission according to the “frequency hopping” method is also possible in an advantageous embodiment. At least two discrete frequencies are used in a fixed or dynamic way according to a transmission protocol in this case. The analysis circuits must merely analyze the presence of the two or more frequencies changing in the rhythm of the data transmission or the on/off keying of a frequency in this case.

Since the actuator, together with other electronic elements, typically forms an oscillating circuit having a very low quality, data transmission through frequency modulation, especially frequency hopping, is especially advantageous, since only one simple and cost-effective circuit system having only a slight power consumption is required for this purpose.

In principle, the data transmission may be performed on greatly varying types of actuators, which are inductive, capacitive, or resistive consumers. In an advantageous example embodiment, in which the actuator is an injector having a piezoelectric positioner, the capacitance of the positioner itself forms a component of the oscillating circuit, the inductor of this oscillating circuit being situated in the control unit in this case.

In particular, if the actuator is an injector which has a solenoid valve, an inductor of this magnetic circuit may form a component of the oscillating circuit. The capacitors of the oscillating circuit are situated in the control unit and/or in the consumer in this exemplary embodiment.

For the case in which the actuator is a resistive consumer, an additional inductor, which may be situated in the control unit, and a capacitor, which may be situated in the consumer, are required for implementing an oscillating circuit.

It is especially advantageous that in addition to the data transmission, power supply of the circuit assigned to the actuator and the components of the oscillator may also be implemented by the AC voltage signal. This is performed by rectifying the AC voltage signal. The AC voltage signal is preferably set at a uniform level directly below the response threshold of the actuator for optimum power supply. In addition, circuit systems may be provided in the actuator which amplify the rectified AC voltage signal. Such circuit systems are always required when the voltage due to simple rectification is inadequate to supply the data transmission circuit and other circuits, such as a microcontroller for data processing, data storage, and controlling the data transmission in the consumer. The voltage value may be increased using voltage multiplication, for example, passively using diodes or actively using controlled active switches. In addition, a transformer may also be provided for increasing the voltage. In this case, the inductor of the transformer forms a component of the overall inductance of the oscillating circuit and influences its frequency.

The frequency of the oscillating circuit and/or the capability of the oscillating circuit to produce an oscillation may also be used very advantageously for diagnosing the performance reliability of the control unit, in particular of an output stage of the control unit and/or the actuator.

### BRIEF DESCRIPTION OF THE DRAWING

FIG. 1 schematically shows a block diagram of a device using the present invention.

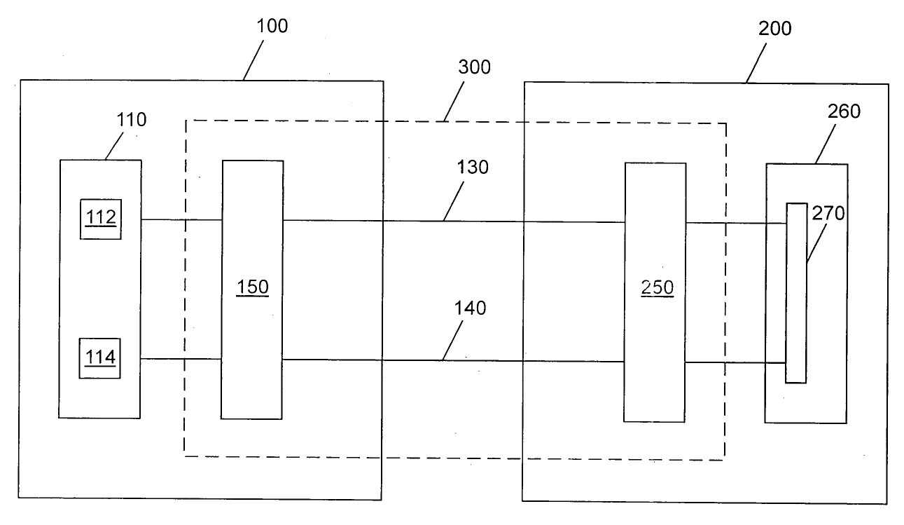

### DETAILED DESCRIPTION OF THE INVENTION

A device for controlling an internal combustion engine, shown in the figure, has a control unit 100. Control unit 100 contains a control module 110, which in turn contains multiple functions. These are, inter alia, a quantity equalization regulator 112 and/or a zero quantity calibrator 114. The control module is connected via supply lines 130, 140 to an actuator 200.

An oscillating circuit 300, also referred to as oscillator, whose components are distributed to control unit 100 and actuator 200, is provided for transmitting data and also energy from control unit 100 to actuator 200 and vice versa. Thus, a first component 150 is situated in control unit 100 and a second component 250 of oscillating circuit 300 is situated in actuator 200. First component 150 in control unit 100 may be formed by a capacitor and/or inductor, for example. Second component 250 in actuator 200 may similarly be implemented as an inductor and/or capacitor or also by a resistive load. The data is transmitted to a circuit 260 in actuator 200 which stores and/or processes the transmitted data. The data is transmitted through modulated AC voltage signals, multiple different types of modulation being able to be used. Types of modulation which are simple to produce and analyze are amplitude modulation and frequency modulation. Different types of phase modulation, which are known per se from the telecommunications field, may also be used.

In the simplest case, two discrete sine frequencies are used for the data transmission, or on/off keying of oscillator 300 is used. In addition, data transmission according to the “frequency hopping” method is possible. At least two discrete frequencies are used in a fixed or dynamic way according to a transmission protocol. In this case, the analysis circuits must merely analyze the presence of two or more frequencies changing the rhythm of the data transmission or the on/off keying of a frequency.

Frequency modulation, in particular frequency hopping, has been shown to be especially advantageous in experiments. Since oscillating circuit 300 is generally of low quality, frequency modulation allows low power consumption and a simple and a cost-effective circuit system. To produce the frequency modulation, a reactance, e.g., a capacitor, is connected in parallel (not shown) to oscillating circuit 300 in control unit 100 or actuator 200 using an electronic switch.

The frequency changes are analyzed using frequency discriminators which are a part of circuit 260, by counting the times between zero crossings or exceeding of predefinable thresholds in the signal. In particular, circuit 260 may have a microcontroller. This applies similarly to control module 110 also. Control module 110 may simultaneously demodulate the transmitted data again, i.e., receive it, in order to obtain information about the quality of the transmitted information.

In addition, control circuit 260 may transmit the received data or other information, such as checksums or the like, to control module 110, in order to thus give control unit 100 information about the bidirectional transmission link. If there is no possibility of establishing data transmission to actuator 200, in particular when oscillator 300 is not capable of forming an oscillator or massive frequency errors occur, it may be concluded that actuator 200 has a fault. Indirect detection of faults of actuator 200 is thus also possible.

It is particularly advantageous that the AC voltage signal may also be provided for the power supply of components 250 of oscillator 300 situated in actuator 200 and also circuit 260 assigned to actuator 200. For this purpose, the AC voltage signal is rectified and possibly amplified in a suitable way. The circuit for rectification and amplification 270 is a part of circuit 260, for example—as shown.

Component 150 of oscillator 300 may also be coupled capacitively and/or via electronic or electromechanical switches to existing output stage circuits of control module 110 (not shown), for example. In this way, it is ensured that the normal function of the output stage and actuator 200 is not impaired.

To avoid rectifying effects on unpowered semiconductors of the output stage of control unit 100, auxiliary current sources or pull-up resistors in the reverse direction, which produce a bias voltage, may be provided. This bias voltage is used simultaneously in actuators which have piezoelectric consumers to prevent their piezoceramics from being reshaped.

The AC voltage signal produced is a harmonic-poor sine signal. The frequency and/or the frequencies arising during the modulation are placed in a frequency range which is outside broadcast or data transmission frequency bands which may be interfered with. The range from 100 kHz to 140 kHz comes into consideration as a possible frequency range. The range is below the German longwave range and above that of the Mainflingen time signal transmitter. Other frequency ranges are also conceivable. These are tailored to the actuators. It is to be emphasized that the frequencies do not have to be kept very stable. They must merely be inside the predefined limits of the frequency band available. For this reason, the capacitors of oscillating circuit 300 may be implemented by inexpensive ceramic capacitors having a tolerance of ±10%.

The device described above for bidirectional transmission of data from control unit 100 to actuator 200 may additionally be used for diagnosis of actuator 200, in particular for diagnosis of an output stage of the actuator, which is a part of control module 110, and/or actuator 200. For this purpose, the frequency of oscillating circuit 300 in control module 110 is analyzed and/or the capability of oscillating circuit 300 to produce an oscillation is used to diagnose the operating capability of control module 110, in particular an output stage, which is a part of this control module 110, or of actuator 200. If the frequency deviates from a predefinable value, for example, or oscillating circuit 300 does not produce any oscillations, a defect of control unit 100 and/or of actuator 200 is assumed.

1-12. (canceled)

13. A device for controlling an internal combustion engine, comprising:
a data medium assigned to at least one actuator;
a control unit configured to at least one of read data from the data medium and write data into the data medium, wherein the at least one of reading data from the data medium and writing data into the data medium is performed by an oscillating circuit, and wherein components of the oscillating circuit are situated in at least one of the control unit and a circuit assigned to the actuator.

14. The device as recited in claim 13, wherein the oscillating circuit produces a modulated AC voltage signal which is transmitted via power supply lines of the actuator.

15. The method as recited in claim 14, wherein the AC voltage signal is modulated by at least one of amplitude modulation, frequency modulation, and phase modulation.

16. The device as recited in claim 14, wherein the AC voltage signal has at least two discrete frequencies.

17. The device as recited in claim 16, wherein data transmission using the AC voltage signal is performed through frequency hopping.

18. The device as recited in claim 14, wherein power is supplied to the circuit assigned to the actuator by the AC voltage signal.

19. The device as recited in claim 14, wherein the actuator is an injector for injecting fuel into the internal combustion engine.

20. The device as recited in claim 19, wherein the injector includes a piezoelectric positioner which forms a capacitor of the oscillating circuit, and wherein an inductor of the oscillating circuit is situated in at least one of the control unit and in the actuator.

21. The device as recited in claim 19, wherein the injector includes a solenoid valve which forms an inductor of the oscillating circuit, and wherein a capacitor of the oscillating circuit is situated in at least one of the control unit and in the actuator.

22. The device as recited in claim 19, wherein the actuator is a resistive load which forms the oscillating circuit together with a capacitor and an inductor, and wherein the capacitor is situated in the load and the inductor is situated in the control unit.

23. The device as recited in claim 19, wherein the oscillating circuit is configured as a free-running oscillator.

24. The device as recited in claim 19, wherein the control unit analyzes at least one of: a) frequency of the oscillating circuit; and b) capability of the oscillating circuit to produce an oscillation, whereby the control unit diagnoses performance reliability of at least one of the control unit and the actuator.
